(19) United States
(12) Patent Application Publication
(10) Pub. No.: US 2021/0361986 A1
(43) Pub. Date: Nov. 25, 2021

(54) SHEET-LIKE FILTER, MASK, AND SHEET MANUFACTURING APPARATUS

(71) Applicant: SEIKO EPSON CORPORATION, Tokyo (JP)

(72) Inventors: Satomi YOSHIOKA, Shiojiri (JP); Naotaka HIGUCHI, Suwa-gun Fujimi-machi (JP); Shigeo FUJITA, Matsumoto (JP); Shunichi SEKI, Suwa (JP); Kazuhiro ICHIKAWA, Okaya (JP); Akio ITO, Matsumoto (JP)

(21) Appl. No.: 17/323,002

(22) Filed: May 18, 2021

(30) Foreign Application Priority Data
May 20, 2020 (JP) 2020-088459

(51) Int. Cl. A62B 23/02; A41D 13/11

(52) U.S. Cl. CPC A62B 23/025; A41D 2500/30; A41D 2500/52; A41D 13/1146

(57) ABSTRACT

A sheet-like filter includes a first fiber that is mainly composed of polylactic acid, and a second fiber that is mainly composed of polylactic acid and has a core portion and a cover layer covering the core portion, in which the cover layer functions as a binder for fusing the first fiber and the second fiber. In addition, when a melting point of the core portion is denoted by Tm1 and a melting point of the cover layer is denoted by Tm2, it may be Tm2<Tm1.

The present application is based on, and claims priority from JP Application Serial Number 2020-088459, filed May 20, 2020, the disclosure of which is hereby incorporated by reference herein in its entirety.

### BACKGROUND

### 1. Technical Field

The present disclosure relates to a sheet-like filter, a mask, and a sheet manufacturing apparatus.

### 2. Related Art

For example, as shown in JP-A-2011-92282, a mask that is worn on a head portion and covers the mouth and nose is known. The mask of JP-A-2011-92282 includes a mask body that covers the mouth and nose, and an ear hook portion that can be hung on the ear when worn.

The mask body is composed of a nonwoven fabric made of polyester resin fibers molded by a melt-blow method. The average length of polyester resin fibers is relatively long. Therefore, the mask body is relatively hard to tear and has high rigidity.

However, the mask described in JP-A-2011-92282 has poor flexibility and a poor fit when worn. Furthermore, the fusion strength was insufficient.

### SUMMARY

A sheet-like filter according to the present disclosure includes a first fiber that is mainly composed of polylactic acid, and a second fiber that is mainly composed of polylactic acid and has a core portion and a cover layer covering the core portion, in which the cover layer functions as a binder for fusing the first fiber and the second fiber.

A mask according to the present disclosure includes a sheet-like filter according to the present disclosure.

A sheet manufacturing apparatus according to the present disclosure includes a first sheet supply portion that supplies a first sheet, an accumulating portion that supplies a material including a first fiber that is mainly composed of polylactic acid and a second fiber that is mainly composed of polylactic acid and has a core portion and a cover layer covering the core portion to form an accumulation, a second sheet supply portion that supplies a second sheet to form a laminate in which the first sheet, the accumulation, and the second sheet are laminated, and a molding portion that heats and pressurizes the laminate to fuse the first fiber and the second fiber, and fuses the accumulation with the first sheet and the second sheet to perform molding.

### BRIEF DESCRIPTION OF THE DRAWINGS

FIG. 1 is a perspective view showing a state in which a user wears a mask of the present disclosure.

FIG. 2 is a cross-sectional view of a mask body included in the mask shown in FIG. 1.

FIG. 3 is an enlarged schematic view of a first fiber and a second fiber.

FIG. 4 is a cross-sectional view taken along a line IV-IV in FIG. 3.

FIG. 5 is a cross-sectional view taken along a line V-V in FIG. 3.

FIG. 6 is a schematic configuration diagram showing a mask manufacturing apparatus, which is a first embodiment, shown in FIG. 1.

FIG. 7 is a perspective view showing a manufacturing method for manufacturing the mask shown in FIG. 1.

FIG. 8 is a perspective view showing a manufacturing method for manufacturing the mask shown in FIG. 1.

FIG. 9 is a plan view showing a manufacturing method for manufacturing the mask shown in FIG. 1.

FIG. 10 is a plan view showing a manufacturing method for manufacturing the mask shown in FIG. 1.

FIG. 11 is a schematic configuration diagram showing a mask manufacturing apparatus, which is a second embodiment, of the present disclosure.

### DESCRIPTION OF EXEMPLARY EMBODIMENTS

Hereinafter, a sheet-like filter, a mask, and a sheet manufacturing apparatus of the present disclosure will be described in detail based on the preferred embodiments shown in the accompanying drawings.

### First Embodiment

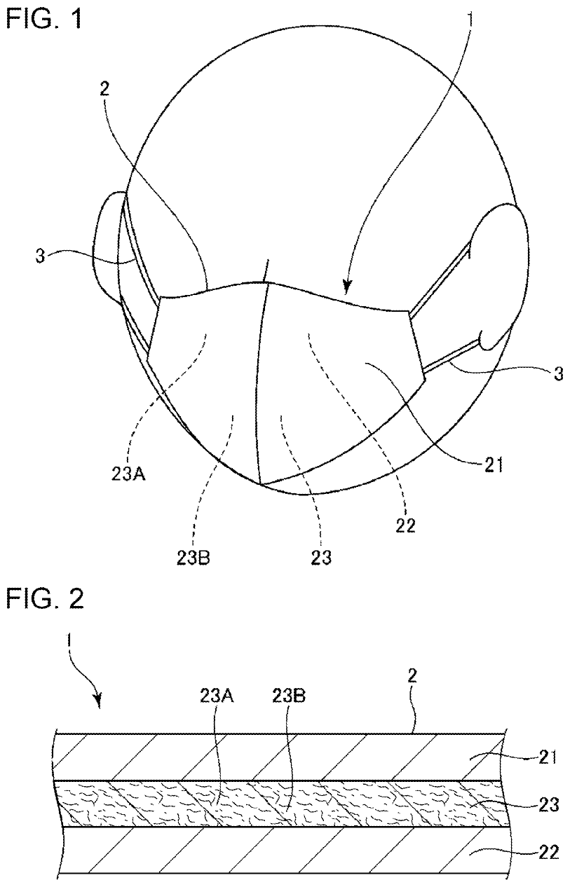

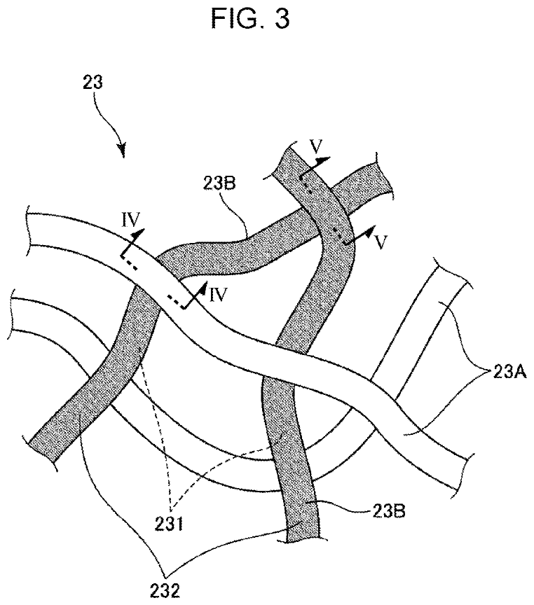

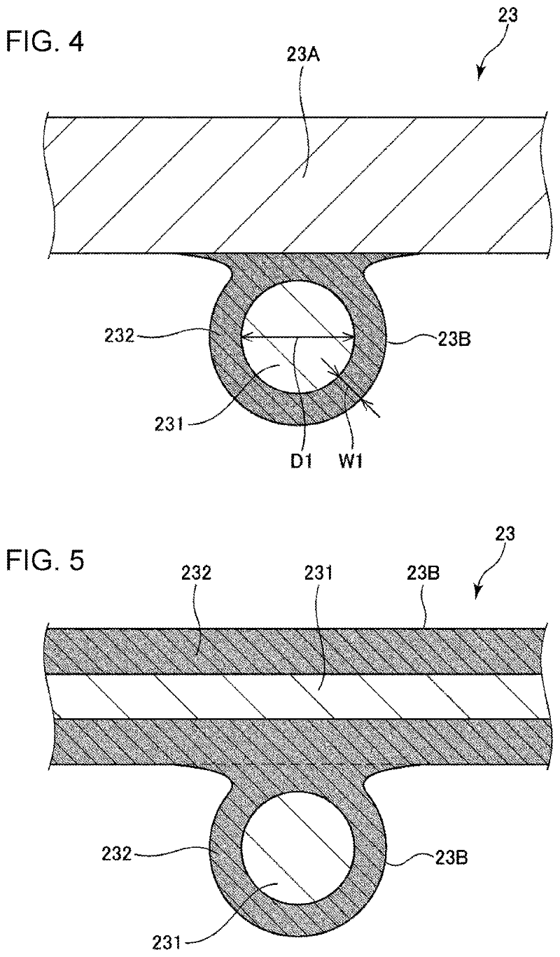

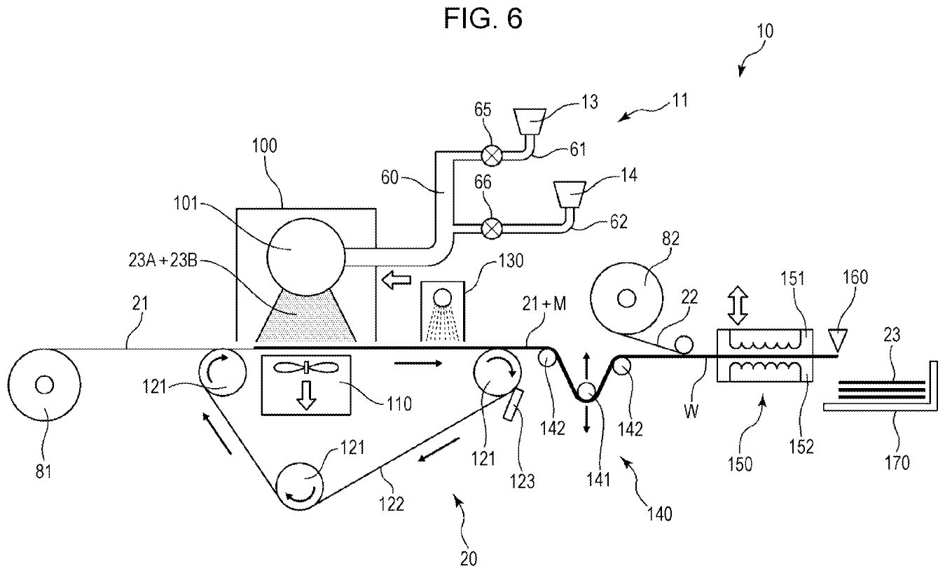

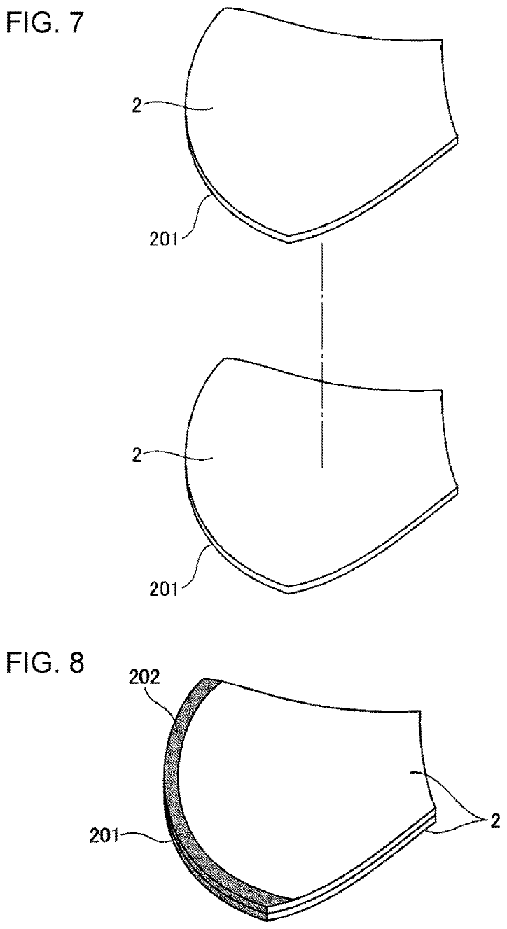

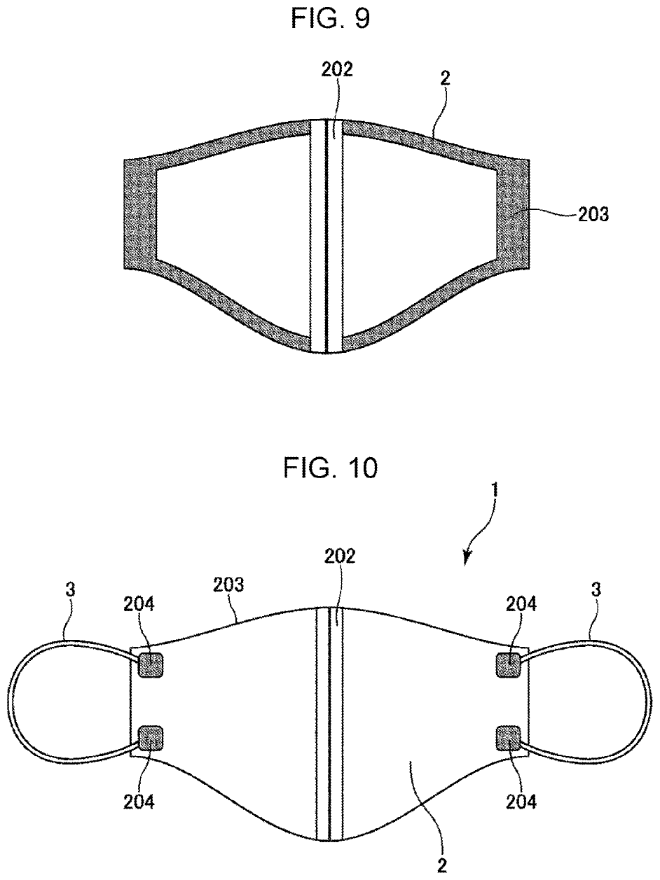

FIG. 1 is a perspective view showing a state in which a user wears a mask of the present disclosure. FIG. 2 is a cross-sectional view of a mask body included in the mask shown in FIG. 1. FIG. 3 is an enlarged schematic view of a first fiber and a second fiber. FIG. 4 is a cross-sectional view taken along a line IV-IV in FIG. 3. FIG. 5 is a cross-sectional view taken along a line V-V in FIG. 3. FIG. 6 is a schematic configuration diagram showing a mask manufacturing apparatus, which is a first embodiment, shown in FIG. 1. FIGS. 7 and 8 are perspective views showing a manufacturing method for manufacturing the mask shown in FIG. 1. FIGS. 9 and 10 are plan views showing a manufacturing method for manufacturing the mask shown in FIG. 1.

In addition, hereinafter, for convenience of explanation, the upper side in FIG. 6 is also referred to as “upper” or “above”, and the lower side is also referred to as “lower” or “below”.

As shown in FIG. 1, a mask 1 is used by being worn on a head portion so as to cover the nose and mouth of a user. When the user wears the mask 1, it is possible to suppress scattering of secretions derived from the respiratory organ from the user while suppressing the user from inhaling dust, infectious droplets, and the like. Hereinafter, a configuration of the mask 1 will be described.

The mask 1 includes a mask body 2 that covers the nose and mouth, and a pair of ear hook portions 3. First, the mask body 2 will be described.

As shown in FIG. 2, the mask body 2 includes a first sheet 21, a second sheet 22, and a sheet-like filter 23 of the present disclosure. These are laminated in an order of the first sheet 21, the sheet-like filter 23, and the second sheet 22.

The first sheet 21 is composed of a sheet having air permeability. The first sheet 21 may be either a woven fabric or a nonwoven fabric. In addition, composing materials of the first sheet 21 are not particularly limited, and examples thereof include polyesters such as PET (polyethylene terephthalate), polyolefins such as PE (polyethylene), PP (polypropylene), and ethylene-propylene copolymer, rayon, cotton, and the like, and one or two or more of these can be used in combination.

In addition, the method for manufacturing the first sheet 21 is not particularly limited, and examples thereof include an air through method, a spunbond method, a needle punch method, a melt blown method, a card method, a heat fusion method, a water flow entanglement method, and a solvent adhesion method.

The second sheet 22 is composed of a material having air permeability like the first sheet 21. The composing material of the second sheet 22 is not particularly limited, and examples thereof include materials exemplified as the composing material of the first sheet 21.

In addition, the method for manufacturing the second sheet 22 is not particularly limited, and example thereof includes the manufacturing method exemplified as the method for manufacturing the first sheet 21.

The thickness of each of the first sheet 21 and the second sheet 22 is not particularly limited, and may be, for example, 0.05 mm or more and 10.0 mm or less, and further may be, 0.1 mm or more and 2.5 mm or less. As a result, it is possible to easily achieve both flexibility and rigidity of the entire mask body 2.

It should be noted that the thicknesses in the first sheet 21 and the second sheet 22 may be the same or different.

In addition, the basis weight of each of the materials in the first sheet 21 and the second sheet 22 may be 5 g/m² or more and 200 g/m² or less, and further may be 8 g/m² or more and 150 g/m² or less. As a result, it is possible to easily achieve both flexibility and rigidity of the entire mask body 2. Furthermore, the bacterial filtration rate and the fine particle filtration rate can be sufficiently increased while ensuring sufficient air permeability.

It should be noted that the basis weight of the materials in the first sheet 21 and the second sheet 22 may be the same or different.

Next, the sheet-like filter 23 will be described.

The sheet-like filter 23 is located between the first sheet 21 and the second sheet 22, and mainly functions as a filter for capturing bacteria, viruses, fine particles, and the like.

The sheet-like filter 23 includes a first fiber 23A mainly composed of polylactic acid, and a second fiber 23B mainly composed of polylactic acid and having a core portion 231 and a cover layer 232 covering the core portion 231.

Polylactic acid is a polymer derived from lactic acid. Polylactic acid may be a polymer containing, for example, 50 mol % or more of component units derived from lactic acid.

Examples of polylactic acid include (a) polymers of lactic acid, (b) copolymers of lactic acid with other aliphatic hydroxycarboxylic acids, (c) copolymers of lactic acid with aliphatic polyhydric alcohols and aliphatic polyhydric carboxylic acids, (d) copolymers of lactic acid with aliphatic polyhydric carboxylic acids, (e) copolymers of lactic acid with aliphatic polyhydric alcohols, and (f) mixtures of any combination of these (a)-(e).

Examples of lactic acid include L-lactic acid, D-lactic acid, DL-lactic acid or cyclic dimers thereof, L-lactide, D-lactide, DL-lactide or a mixture thereof.

Examples of the other aliphatic hydroxycarboxylic acid in (b) above include glycolic acid, hydroxybutyric acid, hydroxyvaleric acid, hydroxycaproic acid, hydroxyheptanic acid, and the like.

Examples of the aliphatic polyhydric alcohol in (c) and (e) include ethylene glycol, 1,4-butanediol, 1,6-hexanediol, 1,4-cyclohexanedimethanol, neopentyl glycol, decamethyleneglycol, glycerol, trimethylolpropane, pentaerythritol, and the like.

Examples of the aliphatic polyvalent carboxylic acid in the above (c) and (d) include succinic acid, adipic acid, suberic acid, sebacic acid, dodecanedicarboxylic acid, succinic anhydride, adipic anhydride, trimesic acid, propanetricarboxylic acid, pyromellitic acid, pyromellitic anhydride, and the like.

Polylactic acid may have crystallinity. As a result, it is possible to effectively suppress heat shrinkage when manufacturing, specifically, when fusing heat. Accordingly, it is possible to obtain the mask 1 having uniform characteristic over a surface direction.

Since the first fiber 23A and the second fiber 23B are mainly composed of the polylactic acid described above, the sheet-like filter 23 is excellent in biodegradability, antibacterial property, and moisture retaining property.

The second fiber 23B has the core portion 231 and the cover layer 232 that covers the core portion 231. The core portion 231 is responsible for increasing the rigidity of the second fiber 23B and increasing the followability of the mask 1 to the face. The cover layer 232 functions as a binder for fusing the first fiber 23A and the second fiber 23B.

As shown in FIG. 3, the first fiber 23A and the second fiber 23B are in a state where the first fiber 23A and the second fiber 23B, and the second fibers 23B are partially fused to each other in a randomly oriented state. That is, the sheet-like filter 23 is a nonwoven fabric including the first fiber 23A and the second fiber 23B. Thus, flexibility and strength can be increased regardless of the direction.

More specifically, as shown in FIG. 4, in a portion where the first fiber 23A and the second fiber 23B are in contact with each other, the cover layer 232 of the second fiber 23B is melted by heat, spreads to an outer surface of the first fiber 23A, and is cured in this state to join the first fiber 23A and the second fiber 23B.

In addition, as shown in FIG. 5, in a portion where the second fibers 23B are in contact with each other, each of cover layers 232 is melted by heat, spreads on the surface of each of the cover layers, and is cured in this state to join the second fibers 23B to each other.

As described above, since the first fibers 23A and the second fibers 23B are partially joined by heat fusion in a randomly oriented state, when viewed as a whole of the sheet-like filter 23, it can be easily deformed while ensuring sufficient strength, and can easily follow the uneven shape of the face of the user.

In particular, in the second fiber 23B, the cover layer 232 functions as a binder for fusing the first fiber 23A and the second fiber 23B. Therefore, it is possible to prevent or suppress the core portion 231 from being melted or excessively deformed during heat fusion. That is, since the core portion 231 remains even after molding, the so-called stiffness of the second fiber 23B can be left. As a result, sufficient strength can be ensured when viewed as a whole of the sheet-like filter 23.

In addition, in the sheet-like filter 23, when a melting point of the core portion 231 is denoted by Tm1 and a melting point of the cover layer 232 is denoted by Tm2, Tm2<Tm1. As a result, when fusing heat described later, the cover layer 232 can be more effectively and primarily melted, and the core portion 231 can be effectively prevented from melting.

In addition, in the sheet-like filter 23, it may be 20° C.≤Tm1−Tm2. As a result, when fusing heat described later, the cover layer 232 can be more reliably and primarily melted, and the core portion 231 can be more effectively prevented from melting.

More specifically, in the sheet-like filter 23, it may be 20° C.≤Tm1−Tm2≤100° C., and further may be 25° C.≤Tm1−Tm2≤90° C. Assuming that a value of Tm1−Tm2 is too small, the possibility of melting and deforming up to the core portion 231 is increased when fusing heat, and a relatively high heating temperature may be required to melt the cover layer 232. On the other hand, assuming that the value of Tm1−Tm2 is too large, it may be difficult to produce such polylactic acid.

In addition, in the sheet-like filter 23, it may be 160° C.≤Tm1. This makes it easier to be 20° C.≤Tm1−Tm2.

More specifically, in the sheet-like filter 23, it may be 160° C.≤Tm1≤200° C., and further may be 165° C.≤Tm1≤190° C. Assuming that a value of Tm1 is too small, the possibility of melting and deforming up to the core portion 231 is increased when fusing heat. On the other hand, assuming that the value of Tm1 is too large, it may be difficult to produce such polylactic acid.

In addition, in the sheet-like filter 23, it may be 120° C.≤Tm2. This makes it easier to be 20° C.≤Tm1−Tm2.

More specifically, in the sheet-like filter 23, it may be 120° C.≤Tm2≤170° C., and further may be 125° C.≤Tm2≤160° C. Assuming that the value of Tm2 is too small, it may be difficult to produce such polylactic acid. On the other hand, assuming that a value of Tm2 is too large, the possibility of melting and deforming up to the core portion 231 is increased when fusing heat.

Such a difference in melting point can be expressed, for example, by making the molecular weight, crystallinity, and the like of polylactic acid different. In addition, the melting point in the present specification is a value obtained in accordance with JIS K 0064-1192.

In addition, the average length of the first fiber 23A and the second fiber 23B is not particularly limited, but may be 0.5 mm or more and 100 mm or less, and further may be 0.5 mm or more and 50 mm or less. As a result, a fusion site of the first fiber 23A and the second fiber 23B and a fusion site of the second fibers 23B can be sufficiently secured. Accordingly, sufficient strength can be secured. Further, the fibers can be easily deformed freely, and the shape followability to the uneven shape of the face can be improved.

In addition, the average width of the first fiber 23A and the second fiber 23B is not particularly limited, but may be 0.5 μm or more and 50 μm or less, and further may be 0.7 μm or more and 40 μm or less. As a result, sufficient strength can be secured, the fibers can be easily deformed freely, and the shape followability to the uneven shape of the face can be improved.

For the same reason, an average aspect ratio of the first fiber 23A and the second fiber 23B, that is, a ratio of the average length to the average width may be 3 or more and 1500 or less, and further may be 10 or more and 800 or less.

The average length and the average width can be obtained by, for example, measuring the average length and the average width with a fiber tester manufactured by Lorentzen & Wettre and calculating a length weighted average value.

In addition, the average lengths of the first fiber 23A and the second fiber 23B may be the same or different. Specifically, when the average length of the first fiber 23A is denoted by LA and the average length of the second fiber 23B is denoted by LB, LA/LB may be 0.2 or more and 5.0 or less, and further may be 0.5 or more and 2.0 or less. Thereby, the effect of the present disclosure can be exhibited evenly.

In addition, the average widths of the first fiber 23A and the second fiber 23B may be the same or different. Specifically, when the average width of the first fiber 23A is denoted by WA and the average width of the second fiber 23B is denoted by WB, WA/WB may be 0.7 or more and 1.3 or less, and further may be 0.8 or more and 1.2 or less. Thereby, the effect of the present disclosure can be exhibited evenly.

As shown in FIG. 4, a ratio of a diameter D1 of the core portion 231 to the thickness W1 of the cover layer 232 is not particularly limited, but may be 0.2 or more and 2.0 or less, and further may be 0.5 or more and 1.5 or less. As a result, even after fusing heat, the core portion 231 can be more reliably left without being deformed.

The thickness of each sheet-like filter 23 is not particularly limited, and may be, for example, 0.1 mm or more and 11.0 mm or less, and further may be, 0.2 mm or more and 2.7 mm or less. As a result, it is possible to easily achieve both flexibility and rigidity of the entire mask body 2.

In addition, the basis weight of each of the materials of the sheet-like filter 23 may be 5 g/m² or more and 600 g/m² or less, and further may be 8 g/m² or more and 300 g/m² or less. As a result, it is possible to easily achieve both flexibility and rigidity of the sheet-like filter 23. Furthermore, the bacterial filtration rate and the fine particle filtration rate can be sufficiently increased while ensuring sufficient air permeability.

In addition, the sheet-like filter 23 may include fibers other than the first fiber 23A and the second fiber 23B, and additives.

The fibers other than the first fiber 23A and the second fiber 23B are not particularly limited and include biodegradable plastics such as polycaprolactone, modified starch, polyhydroxybutyrate, polybutylene succinate, polybutylene succinate, polybutylene succinate adipate, and the like. Further, the fibers may include fibers of petroleum-derived resin, biomass plastic, and natural resin.

Examples of the additive include an antibacterial agent, an antiviral agent, an antifungal agent, a deodorant agent, a neutralizing agent, a fixing agent, a viscosity agent, a sizing agent, a paper strength enhancing agent, a defoaming agent, a water retaining agent, a water resisting agent, a flocculation inhibitor for suppressing flocculation of fibers and flocculation of resins, carbon black, a coloring agent, a flame retardant, and the like.

As described above, the sheet-like filter 23 of the present disclosure includes a first fiber 23A mainly composed of polylactic acid, and a second fiber 23B mainly composed of polylactic acid and having a core portion 231 and a cover layer 232 covering the core portion 231. Then, the cover layer 232 functions as a binder for fusing the first fiber 23A and the second fiber 23B. Thereby, the fusion strength of the first fiber 23A and the second fiber 23B can be increased. Further, since the fusion strength is high, the strength of the sheet-like filter 23 itself can be sufficiently increased, and the degree of freedom of deformation is increased.

In addition, the mask 1 of the present disclosure includes the sheet-like filter 23 of the present disclosure. Thus, while enjoying the advantages of the sheet-like filter 23, the mask 1 excellent in strength and flexibility, and having a high fitting feeling can be obtained.

In addition, the bacterial filtration rate of the mask 1 as defined in ASTM F2100-11 may be 95% or more, and further may be 97% or more.

In addition, the fine particle filtration rate of the mask 1 as defined in ASTM F2100-11 may be 95% or more, and further may be 97% or more.

Further, the expiratory resistance of the mask 1 defined in ASTM F2100-11 may be 30 mm H₂O/cm² or less, and further may be 15 mm H₂O/cm² or less.

Such characteristics of the mask 1 can be achieved by providing the sheet-like filter 23 of the present disclosure.

In the present embodiment, the mask body 2 and the pair of ear hook portion 3 are fused by heat fusion. However, the present disclosure is not limited to this, and the mask body 2 and the ear hook portion 3 may be joined by adhesion via an adhesive, pressure bonding, ultrasonic fusion, or the like. Further, the mask body 2 and the ear hook portion 3 may be integrally formed.

Next, a sheet manufacturing apparatus 10 for manufacturing the mask 1 will be described.

The sheet manufacturing apparatus 10 includes a raw material supply portion 11, a web molding machine 100, a first sheet supply roller 81, a suction apparatus 110, a second sheet supply roller 82, a heating and pressurizing mechanism 150, and a stacker 170.

The raw material supply portion 11 includes a first supply portion 13 that supplies the first fiber 23A and a second supply portion 14 that supplies the second fiber 23B.

The first supply portion 13 is coupled to a transport pipe 60 via a transport pipe 61. A downstream end portion of the transport pipe 60 is coupled to the web molding machine 100. Further, the transport pipe 61 is provided with a valve 65.

The second supply portion 14 is coupled to the transport pipe 60 via the transport pipe 62. Further, the transport pipe 62 is provided with a valve 66. Furthermore, a supply ratio of the first fiber 23A and the second fiber 23B can be adjusted by appropriately adjusting opening degrees of the valve 65 and the valve 66.

The first fiber 23A and the second fiber 23B supplied into the transport pipe 60 are sufficiently mixed and supplied to the web molding machine 100. The transport pipe 60 may be coupled to a third supply portion or a fourth supply portion that supplies the fibers other than the first fiber 23A and the second fiber 23B, and additives.

In addition, a pipe diameter of the transport pipe 61 and a pipe diameter of the transport pipe 62 may be smaller than a pipe diameter of the transport pipe 60. As a result, a wind speed is improved, the first fiber 23A and the second fiber 23B can be loosened in the air flow, and the subsequent mixing can be performed well.

The mixed first fiber 23A and second fiber 23B are introduced into the web molding machine 100 via the transport pipe 60.

The first sheet supply roller 81 is a first sheet supply portion that supplies the first sheet 21 to the web molding machine 100. The first sheet 21 supplied from the first sheet supply roller 81 serves as a base portion of a bottom surface of a fibrous web molded by the web molding machine 100.

The web molding machine 100 has a dispersion mechanism for uniformly dispersing the first fibers 23A and the second fibers 23B in the gas, for example, air, and a mechanism that sucks the defibrated fibers dispersed thereby on a mesh belt 122.

The dispersion mechanism has a former drum, and the first fiber 23A and the second fiber 23B and air are simultaneously supplied into a rotating forming drum 101. Small hole is provided on an outer peripheral portion of the forming drum 101. The first fiber 23A and the second fiber 23B are released from the small hole and dispersed in the gas. The shape of the small hole is not particularly limited, but it may be a long hole of about 5 mm×25 mm. As a result, both productivity and uniformity can be achieved at the same time. It should be noted that the small hole may have other shapes such as a circular shape and an elliptical shape.

A straightening plate (not shown) is installed below the forming drum 101, and the uniformity in the width direction can be adjusted. In addition, below the straightening plate, the mesh belt 122 on which a mesh is formed is arranged. The mesh belt 122 is composed of an endless belt and is tensioned on three tension rollers 121. The rotation of the tension roller 121 causes the mesh belt 122 to move in a direction of an arrow in the drawing. Along with this movement, the first sheet 21 on the mesh belt 122 and an accumulation W of the first fiber 23A and the second fiber 23B are transported to the right side in the drawing.

From the first sheet supply roller 81, the first sheet 21 is supplied onto the mesh belt 122 so as to move at the same speed as the movement of the mesh belt 122.

A surface of the mesh belt 122 is cleaned by a cleaning blade 123 that abuts on the mesh belt 122. The cleaning may be performed by air.

In addition, the suction apparatus 110 is installed on an opposite side of the web molding machine 100 via the mesh belt 122. The suction apparatus 110 sucks the accumulation W of the first fiber 23A and the second fiber 23B via the mesh belt 122. As a result, the thickness of the accumulation W of the first fiber 23A and the second fiber 23B can be made as uniform as possible, and the mask 1 having no unevenness in characteristics can be obtained.

The suction apparatus 110 can be formed by forming a closed box having an open window of a desired size under the mesh belt 122 and sucking gas, for example, air from other than the window to create a vacuum inside the box.

In addition, a filter dust collector may be coupled to the suction apparatus 110.

The composing material of the mesh belt 122 is not particularly limited as long as it secures the suction air amount and has the strength to hold the first sheet 21, and various metal materials, various resin materials, and the like can be used.

The hole diameter of the mesh may be about 10 μm or more and 125 μm or less. As a result, a stable air flow can be formed, and the thickness of the accumulation W of the first fiber 23A and the second fiber 23B can be made as uniform as possible.

In the above configuration, the first fiber 23A and the second fiber 23B transported by the transport pipe 60 are introduced into the web molding machine 100. Then, the first fiber 23A and the second fiber 23B are accumulated on the first sheet 21 on the mesh belt 122 by the suction force of the suction apparatus 110 after passing through a small hole screen on a surface of the forming drum 101. At this time, by moving the mesh belt 122 and the first sheet 21, the accumulation W having a uniform thickness can be formed on the first sheet 21.

In the web molding machine 100, the accumulation amount when the first fiber 23A and the second fiber 23B are accumulated and a density of a sheet completed when fusing heat are determined. For example, when a fiber structure having a thickness of 10 mm and a density of 0.1 cm³ or more and 0.15 cm³ or less is obtained, the thickness of the accumulation W is set to about 40 mm or more and 60 mm or less.

The web molding machine 100, the mesh belt 122, and the suction apparatus 110 supply a material including the first fibers 23A and the second fibers 23B to the first sheet 21. Thereby, the accumulating portion 20 forms the accumulation W on the first sheet 21.

In addition, a water sprayer 130 is provided above the mesh belt 122 and on the downstream of the web molding machine 100. Thereby, the water content of the accumulation W can be adjusted. Further, it is possible to suppress the formation of lumps on the first fiber 23A and the second fiber 23B, and it is possible to improve the quality of the accumulation W.

Furthermore, an additive, for example, a water-soluble flame retardant (for example, APINON 145 manufactured by Sanwa Chemical Co., Ltd.) can be added to the water sprayed by the water sprayer 130. As a result, flame retardancy can be imparted to the molded sheet-like filter 23.

A buffer portion 140 is provided on the downstream of the water sprayer 130. The buffer portion 140 has a tension adjusting roller 141 and a pair of fixed rollers 142. The tension adjusting roller 141 moves up and down between the pair of fixed rollers 142, that is, in a direction intersecting a transport direction of the first sheet 21 and the accumulation W, so that the tension of the first sheet 21 and the accumulation W can be adjusted.

The second sheet supply roller 82 is provided on the downstream of the buffer portion 140. The second sheet supply roller 82 is a second sheet supply portion for supplying the second sheet 22 to the accumulation W on the first sheet 21 to form a laminate M in which the first sheet 21, the accumulation W, and the second sheet 22 are laminated. The second sheet 22 serves as a cover portion on the upper surface side of the accumulation W.

The configuration shown in the drawing is a configuration that the first sheet supply roller 81 supplies the first sheet 21 to the web molding machine 100, and after the accumulation W is formed on the first sheet 21, the second sheet supply roller 82 supplies the second sheet 22. However, the present disclosure is not limited to this, and has a configuration that the web molding machine 100 may be provided with a first sheet supply roller 81 and a second sheet supply roller 82 on the downstream thereof, and the accumulation W formed by the web molding machine 100 may be sandwiched between the first sheet 21 and the second sheet 22.

The laminate M is transported to the heating and pressurizing mechanism 150. The heating and pressurizing mechanism 150 is a portion that executes the heat fusion, and has a first substrate 151 and a second substrate 152 that is configured to be able to move up and down. The heating and pressurizing mechanism 150 is a hot press in which the laminate M is sandwiched between the first substrate 151 and the second substrate 152 and is pressurized at the same time as heating. Specifically, a heater is built in the first substrate 151 and the second substrate 152. As a result, the laminate M sandwiched between the first substrate 151 and the second substrate 152 can be heated.

When this heating and pressurization, as shown in FIGS. 4 and 5, the cover layer 232 of the second fiber 23B melts and spreads on the surface of the adjacent first fiber 23A or the second fiber 23B. In addition, by performing the pressurization at the same time, a fusion point or a fusion area between the first fiber 23A, the second fiber 23B, and the second fibers 23B increases, and the fusion becomes strong. As a result, the accumulation W becomes the sheet-like filter 23.

The cover layer 232 of the second fiber 23B also comes into contact with the composing material of the first sheet 21 and the composing material of the second sheet 22 in a molten state. As a result, the sheet-like filter 23 is fused with the first sheet 21 and the second sheet 22, and the mask body 2 can be obtained.

Further, heating and pressurization may be performed separately, but heating and pressurization may be applied to the accumulation W at the same time. The heating temperature may be a temperature at which the cover layer 232 melts and the core portion 231 does not melt. Specifically, the heating temperature may be 90° C. or more and 170° C. or less, and further may be 110° C. or more and 165° C. or less. Further, the heating time depends on the heating temperature, but the heating time may be a time at which the cover layer 232 is melted and the core portion 231 is not melted. Specifically, it may be 1 second or more and 300 seconds or less, and further may be 3 seconds or more and 150 seconds or less.

After the heating and pressurization is ended, it is necessary to quickly move the molded mask body 2 and set the next laminate M. Therefore, a mechanism may be provided for inserting, holding and pulling out a needle at an outlet for heating and pressurization.

The heating and pressurizing mechanism 150 may be configured to perform heating and pressurization while being transported by a pair of rollers. As a result, the laminate M can be continuously heated and pressurized, and the productivity is excellent.

The mask body 2 obtained as described above is cut into a desired size and shape by a cutting machine 160, loaded on a stacker 170 as a raw fabric, and cooled.

The cutting machine 160 is not particularly limited, and for example, an ultrasonic cutter or the like can be publicly used. The cutting by the ultrasonic cutter may be cut in one direction in the width direction of the fiber structure, or may be cut in a reciprocating direction opposite to one direction. In addition to the ultrasonic cutter, a rotary cutter, an octagonal rotary cutter, or the like may be used.

The cutting machine 160 may be omitted, and the raw fabric may be wound into a roll.

As described above, the sheet manufacturing apparatus 10 includes the first sheet supply roller 81 serving as the first sheet supply portion that supplies the first sheet 21, the accumulating portion 20 that supplies the material including the first fiber 23A that is mainly composed of polylactic acid and the second fiber 23B that is mainly composed of polylactic acid and has the core portion 231 and the cover layer 232 covering the core portion 231 to form the accumulation W, the second sheet supply roller 82 serving as the second sheet supply portion that supplies the second sheet 22 to form the laminate M in which the first sheet 21, the accumulation W, and the second sheet 22 are laminated, and the heating and pressurizing mechanism 150 serving as the molding portion that heats and pressurizes the laminate M to fuse the first fiber 23A and the second fiber 23B, and fuses the accumulation W with the first sheet 21 and the second sheet 22 to perform molding. Thereby, the fusion strength of the first fiber 23A and the second fiber 23B can be increased, and the mask body 2 having high strength can be obtained. Further, since the fusion strength of the first fiber 23A and the second fiber 23B is high, the degree of freedom of deformation is increased. As a result, it is possible to obtain a mask body 2 that easily follows the unevenness of the face and has a high fit.

The first sheet supply roller 81 serving as the first sheet supply portion supplies the first sheet 21 to the upper surface of the accumulation W shown in FIG. 6 which is the first surface, and the second sheet supply roller 82 serving as the second sheet supply portion supplies the second sheet 22 to the lower surface of the accumulation W shown in FIG. 6 which is the second surface on the side opposite to the upper surface of the accumulation W. As a result, the laminate M in which the first sheet 21, the accumulation W, and the second sheet 22 are laminated in this order can be obtained. Therefore, in the molded mask body 2, the sheet-like filter 23 can be protected by the first sheet 21 and the second sheet 22.

In addition, the raw fabric of the mask body 2 stacked in the stacker 170 is manufactured in the mask 1 as follows. Hereinafter, this manufacturing method will be described.

The raw fabric of the mask body 2 is punched, for example, by a Thomson mold or the like, into the shape shown in FIG. 7. In this embodiment, a bottom portion has a substantially trapezoidal shape with an arc shape. Then, two raw fabrics of the mask body 2 having this shape are prepared and stacked.

Next, as shown in FIG. 8, the edge portions 201 having the arc shape are joined to each other by heat fusion. As a result, as shown in FIG. 9, when unfolded, the mask body 2 having the fusion portion 202 formed in the central portion can be obtained. The heating conditions are not particularly limited, and may be, for example, the heating temperature and the heating time when fusing heat as described above.

Next, as shown in FIG. 9, in the mask body 2 in the unfolded state, the entire circumference of the edge portion is fused. As a result, it is possible to obtain the mask body 2 in which the fusion portion 203 is formed on the entire circumference of the edge portion.

Then, as shown in FIG. 10, the pair of ear hook portion 3 are joined by heat fusion. That is, four fusion portions 204 are formed. As a result, the mask 1 can be obtained.

In addition, in FIGS. 8 to 10, when heat fusion is performed, high fusion strength can be obtained by the cover layer 232 of the second fiber 23B as described above. As a result, the mask 1 having high strength can be obtained.

### Second Embodiment

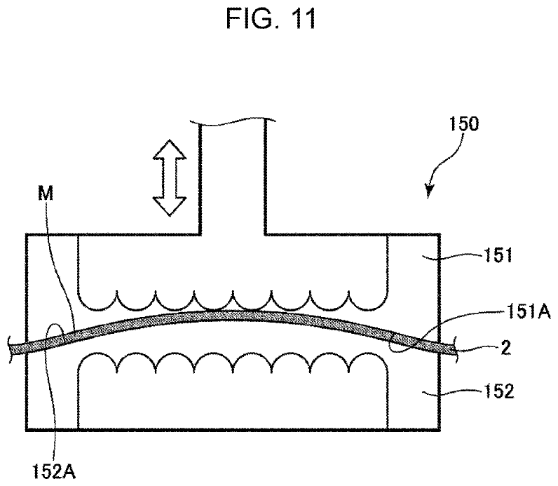

FIG. 11 is a schematic configuration diagram showing a mask manufacturing apparatus, which is a second embodiment, of the present disclosure.

Hereinafter, the second embodiment of the sheet-like filter, mask, and sheet manufacturing apparatus of the present disclosure will be described with reference to the drawings, but differences from the above-described embodiment will be mainly described, and similar matters will not be described.

As shown in FIG. 11, in the heating and pressurizing mechanism 150 of the present embodiment, the first substrate 151 has a curved concave surface 151A, and the second substrate 152 has a curved convex surface 152A corresponding to the curved concave surface 151A. When the first substrate 151 approaches the second substrate 152, the curved convex surface 152A enters the curved concave surface 151A. At this time, the accumulation W between the first substrate 151 and the second substrate 152 is formed in a curved shape corresponding to the curved concave surface 151A and the curved convex surface 152A. Therefore, it is possible to obtain the mask body 2 which is entirely curved in one direction.

According to such a method, fusing heat shown in FIGS. 8 and 9 described in the first embodiment can be omitted. Therefore, the mask 1 can be manufactured by a simple method. Further, since the obtained mask 1 has a shape that resembles the shape of the face to some extent, the fit can be further improved.

As described above, the sheet-like filter, mask, and sheet manufacturing apparatus of the present disclosure were described based on the shown embodiment, the present disclosure is not limited to this, and the configuration of each portion can be replaced with any structure or process having the same function. Further, any other configurations and processes may be added to the sheet-like filter, mask, and sheet manufacturing apparatus of the present disclosure.

What is claimed is:

1. A sheet-like filter comprising:
a first fiber that is mainly composed of polylactic acid; and
a second fiber that is mainly composed of polylactic acid and has a core portion and a cover layer covering the core portion, wherein
the cover layer functions as a binder for fusing the first fiber and the second fiber.

2. The sheet-like filter according to claim 1, wherein
when a melting point of the core portion is denoted by Tm1 and a melting point of the cover layer is denoted by Tm2, Tm2<Tm1.

3. The sheet-like filter according to claim 2, wherein
20° C.≤Tm1−Tm2.

4. The sheet-like filter according to claim 2, wherein
160° C.≤Tm1.

5. The sheet-like filter according to claim 2, wherein
120° C.≤Tm2.

6. The sheet-like filter according to claim 1, wherein
the sheet-like filter is a nonwoven fabric.

7. A mask comprising:
the sheet-like filter according to claim 1.

8. A sheet manufacturing apparatus comprising:
a first sheet supply portion that supplies a first sheet;
an accumulating portion that supplies a material including a first fiber that is mainly composed of polylactic acid and a second fiber that is mainly composed of polylactic acid and has a core portion and a cover layer covering the core portion to form an accumulation;
a second sheet supply portion that supplies a second sheet to form a laminate in which the first sheet, the accumulation, and the second sheet are laminated; and
a molding portion that heats and pressurizes the laminate to fuse the first fiber and the second fiber, and fuses the accumulation with the first sheet and the second sheet to perform molding.

9. The sheet manufacturing apparatus according to claim 8, wherein
the first sheet supply portion supplies the first sheet to a first surface of the accumulation, and
the second sheet supply portion supplies the second sheet to a second surface of the accumulation opposite to the first surface.
